(19) United States
(12) Patent Application Publication
(10) Pub. No.: US 2025/0316406 A1
(43) Pub. Date: Oct. 9, 2025

(54) CABLES HAVING INTERLOCKING ARMOR LAYERS FORMED FROM AN IMPROVED ALUMINUM ALLOY AND METHODS OF FORMING THE SAME

(71) Applicant: Prysmian S.p.A., Milano (IT)

(72) Inventors: Daniel Klenosky, Zionsville, IN (US); Janusz Stanislaw Sekunda, Williamsport, PA (US); Guillermo Garza, Jonquire (CA)

(21) Appl. No.: 18/629,429

(22) Filed: Apr. 8, 2024

(51) Int. Cl. H01B 7/20; C22C 21/06; H01B 7/18

(52) U.S. Cl. CPC H01B 7/205; C22C 21/06; H01B 7/184

(57) ABSTRACT

Cables having interlocking armor layers formed from improved aluminum alloys are disclosed. The aluminum alloys include magnesium and manganese and are capable of being formed without heat treatment upon formation of an aluminum alloy strip. The interlocking armor layers exhibit strength, ductility, and formability. Methods of making the interlocking armor layers are further disclosed.

### TECHNICAL FIELD

The present disclosure generally relates to cables having an interlocking armor layer and methods of forming the same. The present disclosure further relates to an interlocking armor layer for a cable formed from an improved aluminum alloy having sufficient strength, ductility, and formability.

### BACKGROUND

Aluminum alloys used to form armor layers for cables are needed to balance multiple properties. For example, such metal alloys offer high strength, to protect the conductors and allow the conductors to span large distances, and provide high formability that allows for an aluminum alloy strip to be wound on the cable to form the armor layer. There remains a need for armor layers that can provide such properties while allowing for efficient methods of forming the same.

U.S. Pat. No. 5,380,376 describes an armored cable wrap made from an aluminum alloy strip material formed of an aluminum alloy containing about 2.8%-3.5% by weight magnesium, about 0.25%-0.70% by weight manganese, about 0.15%-0.35% by weight chromium, and up to 0.5% by weight of copper.

U.S. Pat. No. 7,536,072 describes an armored electrical or optical cable having at least one flexible elongated conducting member and an armor layer surrounding the conducting member, where the armor layer includes a 5xxx aluminum alloy having greater than 3 wt. % magnesium.

U.S. Patent Publication No. 2023/0016262 describes an aluminum alloy exhibiting improved castability, while meeting or exceeding the ambient temperature strength and formability requirements for high strength applications, where the aluminum alloy includes 1.0%-2.0% by weight magnesium, 0.2%-0.95% by weight manganese, and 0.05%-0.35% by weight chromium, with the balance being aluminum and inevitable impurities.

### SUMMARY

In accordance with one embodiment, a cable includes a cable core including one or more conductors; and an interlocking armor layer surrounding the cable core, the interlocking armor layer formed from an aluminum alloy, the aluminum alloy including about 1.3% to about 1.7%, by weight, magnesium; about 0.05% to about 0.15%, by weight, manganese; and the balance is aluminum.

In accordance with another embodiment, a method of forming an interlocking armor layer for a cable includes making an aluminum alloy strip formed from an aluminum alloy; and forming the aluminum alloy strip into the interlocking armor layer; wherein the aluminum alloy includes about 1.3% to about 1.7%, by weight, magnesium; about 0.05% to about 0.15%, by weight, manganese; and the balance is aluminum; wherein no heat treatment is applied once the aluminum alloy strip is made.

### BRIEF DESCRIPTION OF THE DRAWINGS

FIG. 1 depicts a perspective view of a cable in accordance with certain embodiments;

FIG. 2A depicts a cross-sectional view of an aluminum alloy strip in accordance with one embodiment;

FIG. 2B depicts a cross-sectional view of an aluminum alloy strip in accordance with another embodiment; and

FIG. 2C depicts a cross-sectional view of an aluminum alloy strip in accordance with another embodiment.

### DETAILED DESCRIPTION

Armor layers for cables are typically manufactured with aluminum, or an aluminum alloy, as a consequence of the benefits associated with aluminum's cost, weight, strength, and formability, among other properties, compared to other metals. The formation of aluminum alloys which exhibit improved ductility, formability, and strength have been presently discovered. Further, the cost-effective methods by which such improved aluminum alloys can be formed are desirable and can reduce the carbon footprint for cables formed from the same.

The improved aluminum alloys described herein include amounts of magnesium and manganese that were discovered to provide desirable properties. Aluminum alloy strips used to form interlocking armor layers can be formed from these improved aluminum alloys that can be advantageously formed with no heat treatment step after an aluminum alloy strip is made.

Specifically, it has been discovered that aluminum alloys including, by weight, about 1.3% to about 1.7% magnesium and about 0.05% to about 0.15% manganese can be used to form aluminum alloy strips which can exhibit desirable formability, ductility, and strength. As can be appreciated, the aluminum alloys described herein can include any amounts of magnesium and manganese between the described ranges. For example, in certain embodiments, the aluminum alloys can include about 1.4% to about 1.6%, by weight, magnesium, or about 1.5%, by weight, magnesium. In certain embodiments, the aluminum alloys can include about 0.08% to about 0.13%, by weight, manganese, or about 0.1% to about 0.12%, by weight, manganese. In certain embodiments, the aluminum alloys can include at least about 97.5%, by weight, aluminum; and in certain embodiments, the aluminum alloys can include at least about 98%, by weight, aluminum. It will be appreciated, however, that aluminum can be the balance of the aluminum alloy.

In addition to magnesium and manganese, other metals can be included in the improved aluminum alloys, including for example, chromium. In certain embodiments, the improved aluminum alloys described herein can include, by weight, up to about 0.15% chromium; in certain embodiments, up to about 0.1%, by weight, chromium; and in certain embodiments, up to about 0.08%, by weight, chromium. In certain embodiments, the improved aluminum alloys described herein can include, by weight, up to about 0.2% iron; in certain embodiments, up to about 0.15%, by weight, iron; and in certain embodiments, up to about 0.11%, by weight, iron. In certain embodiments, the aluminum alloys described herein can consist essentially of about 1.3% to about 1.7%, by weight, magnesium; about 0.05% to about 0.15%, by weight, manganese; up to about 0.15%, by weight, chromium; up to about 0.2%, by weight, iron; up to about 0.15%, by weight, of total impurities; and the balance is aluminum.

It is generally understood and appreciated that strength of the aluminum alloy increases linearly with the addition of magnesium and manganese and correlates inversely with formability and ductility. However, the improved aluminum alloys described herein have lower loading levels of magnesium and manganese, relative to other conventional aluminum alloys used for armor layers, but have been unexpectedly discovered to provide a desirable balance of formability, ductility, and strength. For example, aluminum alloy strips formed from these improved aluminum alloys do not require further heat treatment (e.g., annealing) when formed into an interlocking armor layer for a cable.

As can be appreciated, a number of aluminum alloy grades have been standardized by the Accrediting Standards Committee H35 of the Aluminum Association. Standardized aluminum grades are defined by their elemental compositions with the various grades generally intended for specific applications and industries. In certain embodiments, the aluminum alloys described herein can be generally characterized as a 5000-series aluminum alloy including, for example, AA5050 aluminum alloys. Given the lower loading levels of magnesium and manganese relative to other conventional aluminum alloys used for armor layers, however, AA5050 aluminum alloys have not been employed in conventional armor layers, as it has been generally understood and appreciated that AA5050 aluminum alloys do not have the requisite strength, among other properties.

The aluminum alloy strips made from the improved aluminum alloys described herein can exhibit desirable formability, ductility, and strength comparable to strips made from AA5154 aluminum alloys, which include higher levels of magnesium (e.g., 3.1%-3.9%) and are used in conventional armor layers. In contrast to the aluminum alloy strips described herein, however, conventional armor layers made from AA5154 aluminum alloy strips require annealing to provide desirable balance of formability, ductility, and strength.

AA5050 aluminum alloys can include, by weight, 1.1% to 1.8% magnesium, 0.40% or less silicon, 0.70% or less iron, 0.20% or less copper, 0.30% or less manganese, 0.10% or less chromium, 0.25% or less zinc, and 0.05% or less of each other element with a total of less than 0.15% of each other element, and the remainder aluminum.

As can be appreciated, relatively small quantities of other inadvertent elements may also be present in the aluminum alloys described herein due to, for example, processing and refinement impurities. Examples of such elements can include copper, zinc, and silicon. That is, in certain embodiments, one or more such elements may not be intentionally included within the aluminum alloys and only present as impurities. In certain embodiments, the aluminum alloys described herein can include, by weight, 0.05% or less of each other element with a total of less than 0.15% of each other element, and the remainder aluminum; and in certain embodiments, 0.03% or less of each other element with a total of less than 0.10% of each other element, and the remainder aluminum.

Cables having armored layers formed from the improved aluminum alloys described herein have been advantageously discovered to exhibit desirable strength, ductility, and formability, such that aluminum alloys strips made from such aluminum alloys do not require further heat treatment (e.g., annealing) when formed into the interlocking armor layer. Prior to the present discovery, it was believed that a heat treatment, such as annealing, would be necessary to provide the requisite formability, ductility, and strength of a conventional aluminum alloy to form the armor layer in addition to relatively higher quantities of magnesium and manganese.

As can be appreciated, it would be desirable to minimize the amount of heat treatments given the considerable energy, special equipment, and costs required by such processes. Further, minimizing the amount of heat treatments required to form an interlocking armor layer for a cable can also reduce the carbon footprint when manufacturing the cables. Aluminum alloy strips can be formed from the aluminum alloys described herein, with the relatively lower loading levels of magnesium and manganese, by conventional methods, but the strips can be formed into an interlocking armor layer without an additional heat treatment step (e.g., annealing).

As used herein, a “heat treatment” generally refers to a process in which the aluminum alloy is purposely exposed to an external heat source or environment. Types of heat treatment can include, for example, annealing, strain hardening, age hardening, inline heating, and solution heat treatment.

In certain embodiments, the aluminum alloy strips can have a thickness of about 0.016 in. to about 0.025 in. In certain embodiments, the aluminum alloy strips can have a thickness of about 0.022 in. It will be appreciated, however, that an aluminum alloy strip can have any of wide range of suitable thicknesses.

In certain embodiments, the interlocking armor layers formed from the aluminum alloy strips described herein can meet or exceed the requirements of UL 1 (2023). In certain embodiments, cables formed with the interlocking armor layers described herein can meet or exceed the requirements of one or more of Underwriters Laboratory (“UL”) 4 (2021), UL 1569 (2018), and Canadian Standard Association (“CSA”) Group standard C22.2 No. 51:20 (2000). As can be appreciated, meeting, or exceeding, the requirements of the above-referenced standards was previously thought to require annealing or an additional heat treatment step following the aluminum alloy strip being made.

Such standards typically require cables and/or armor layers to exhibit a certain level of flexibility and strength, among other property characteristics. Accordingly, the cables and interlocking armor layers described herein can exhibit such properties. For example, with respect to flexibility, cables may be required to be bent around mandrels of certain sizes without damage to a conductor assembly and without any openings in an armor layer. In certain embodiments, the cables can exhibit a sufficient bend radius in accordance with the above-described standards. For example, in certain embodiments, the cables can exhibit a bend radius that is a minimum of nine times the overall diameter of the cable; in certain embodiments, a bend radius that is a minimum of eight times the overall diameter of the cable; in certain embodiments, a bend radius that is a minimum of seven times the overall diameter of the cable; in certain embodiments, a bend radius that is a minimum of six times the overall diameter of the cable; in certain embodiments, a bend radius that is a minimum of five times the overall diameter of the cable; in certain embodiments, a bend radius that is a minimum of four times the overall diameter of the cable; and in certain embodiments, a bend radius that is a minimum of three times the overall diameter of the cable.

With respect to strength, an armor layer of a cable may be required to exhibit sufficient strength to withstand, without opening up, a particular amount of axial tension. In certain embodiments, the interlocking armor layer of the cables described herein can withstand an axial tension imparted by a weight of 150 lb., for armor having a flat cross-section, and 300 lb., for armor having a circular cross-section.

As can be appreciated, the characteristics of the cables and interlocking armor layers described herein can confer multiple advantages. As noted above, given the considerable energy, special equipment, and costs required by heat treatments, e.g. annealing, eliminating such processes would be desirable to reduce production costs for and the carbon footprint of the cables. Moreover, not only can such heat treatments be an extra processing step, these heat treatments can be a bottleneck in an otherwise continuous process. The improved aluminum alloys described herein can be made having sufficient formability to be wound into the interlocking armor layers described herein without annealing or other heat treatment, such that a method of forming the interlocking armor layer can be continuous.

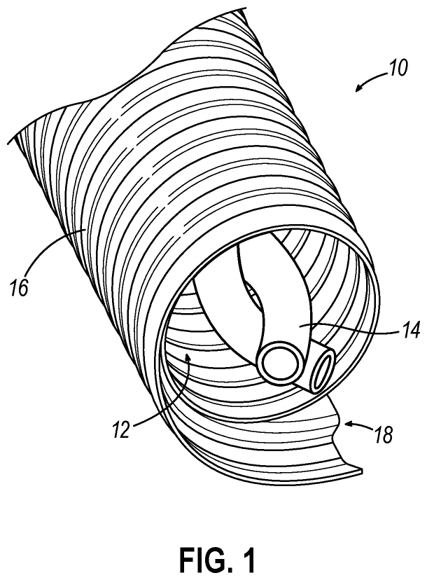

FIG. 1 illustrates a cross-section of a cable 10 according to certain embodiments. The cable 10 can include a cable core 12 including one or more conductors 14. The cable core 12 can be surrounded by an interlocking armor layer 16 formed from an aluminum alloy strip 18, which can be made from the improved aluminum alloys described herein. In certain embodiments, the interlocking armor layer 16 can be formed from a continuous aluminum alloy strip 18.

As shown in FIG. 1, the cable core 12 can include a twisted pair of conductors 14. It will be appreciated, however, that a cable core can include any of a variety of suitable conductors as known in the art in any suitable amount or configuration.

While FIG. 1 depicts the cable 12 as not having an outer jacket layer, in certain embodiments, the cable 12 can further include an outer jacket layer. Likewise, it will be appreciated that a cable can include any of a variety of additional layers as known in the art, within or surrounding the interlocking armor layer, in any suitable configuration.

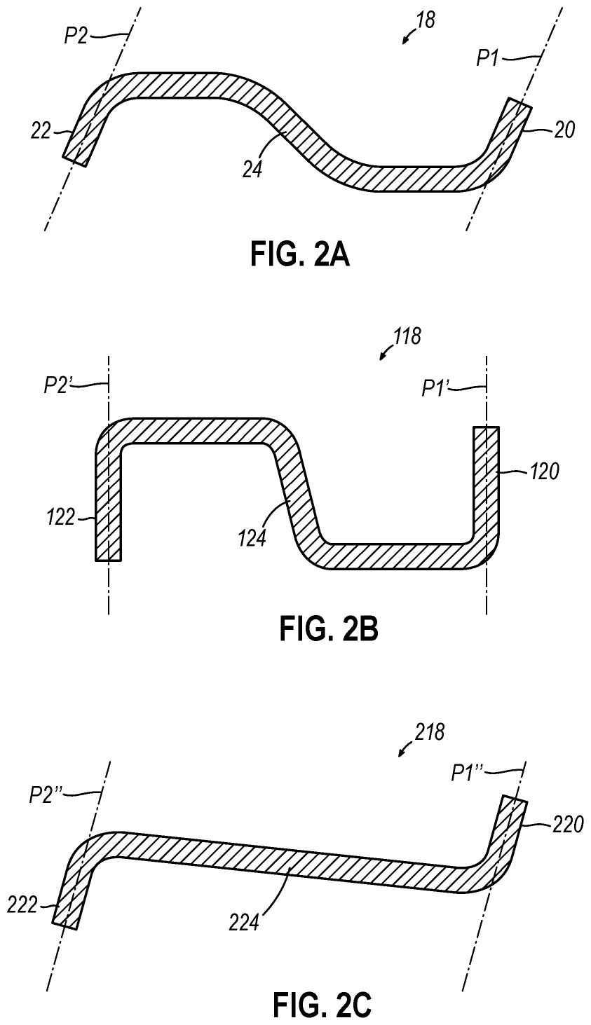

FIGS. 2A, 2B and 2C illustrate a cross-section of an aluminum alloy strip 18, 118, 218. The aluminum alloy strip 18, 118, 218 can have a top surface and a bottom surface and a first edge 20, 120, 220 extending upwardly and a second edge 22, 122, 222 extending downwardly. The aluminum alloy strip 18, 118, 218 can be wound such that the top surface of the first edge 20, 120, 220 can engage the bottom surface of the second edge 22, 122, 222 to form an interlocking armor layer 16 as illustrated in FIG. 1 for example.

In certain embodiments, a first plane P1, defined by the first edge 20, and a second plane P2, defined by the second edge 22, can be substantially parallel to each other. By “substantially parallel,” it will be understood that the respective planes P1, P2 formed by each of the first edge 20 and second edge 22 can be parallel or within 10 degrees of being parallel. For example, as shown FIG. 2A, the first and second planes P1, P2 are shown to be parallel to each other. Similarly, the first and second planes P1′, P2′, as defined by the first and second edges 120, 122, are shown in FIG. 2B to be parallel to each other, and the first and second planes P1″, P2″, as defined by the first and second edges 220, 222, are shown in FIG. 2C to be parallel to each other As shown in FIGS. 2A-2C, the aluminum alloy strip 18, 118, 218 can include a central portion 24, 124, 224 between the first edge 20, 120, 220 and the second edge 22, 122, 222. As the central portion 24, 124, 224 is shown in FIGS. 2A-2C to have different configurations, it will be appreciated that a central portion of an aluminum strip can be curved, bent, substantially flat, or have any of a variety of suitable configurations.

In certain embodiments, the aluminum alloys described herein can alternatively be used for transmission line accessories including transformers, insulators, dead-ends/termination products, splices/joints, products, suspension and support products, motion control/vibration products “dampers”, guying products, wildlife protection and deterrent products, conductor and compression fitting repair parts, substation products, clamps and other transmission and distribution accessories. Alternatively, the aluminum alloys can also be used for any other known application for which a 5000-series aluminum alloy is useful.

In certain embodiments, a method of forming an interlocking armor layer for a cable can include making the aluminum alloy strip (e.g., 18) formed from the aluminum alloy described herein and forming the aluminum alloy strip into the interlocking armor layer (e.g., 16). The aluminum alloys described herein can be formed through a casting process. For example, substantially pure aluminum can be melted at a temperature of about 650° C. or higher (1200° F. or higher) and then additional elements such as magnesium and manganese can be added in accordance with their desired weight percentage. It will be appreciated, however, that aluminum to be melted can include up to about 0.2%, by weight, iron. In certain embodiments, certain optional elements (e.g., chromium) can be added. Once all of the elements are present in accordance with their desired weight percentage, the molten aluminum mixture can be cast. Alternatively, an existing aluminum alloy can be melted, and additional elements can be incorporated. In certain embodiments, a hot casting process can be used as known in the art.

As can be appreciated, many variations to the process of casting an aluminum alloy are known. For example, various stirring steps can be performed on a molten aluminum mixture to improve homogeneity. Additionally, or alternatively, a molten aluminum mixture can be allowed to settle for a period of time to allow unwanted inclusion particles to be deposited as sediment and be removed. In certain embodiments, a molten aluminum mixture can also be refined to remove impurities using, for example, alloying constituents and precise temperature control to precipitate undesired impurities out of the molten mixture.

In certain embodiments, once cast, the aluminum alloy can be exposed to a bar heater and subjected to rod rolling to form a rod. In certain embodiments, the resulting rod can be hot coiled and then air cooled. Alternatively, the resulting rod can be quenched and then air cooled to about room temperature. Hot coiling can allow the rod to retain heat for a longer amount of time relative to quenching. The extra heat can allow for partial annealing of the aluminum alloy strip, minimizing some of the strengthening provided during rod rolling. In certain embodiments, quenching can be preferred over hot coiling, as quenching can provide a safer option for operation. In certain embodiments, hot coiling can be preferred over quenching, as hot coiling can more effectively impart certain properties to the aluminum alloy and can allow for better processability.

In certain embodiments, forming the aluminum alloy strip into the armor layer can further include strip rolling, in which the rod is formed into a flat aluminum alloy strip. It will be appreciated that other suitable types of heat treatments can be employed prior to strip rolling, in addition to or in place of that which is described herein.

In certain embodiments, forming the aluminum alloy strip into the interlocking armor layer can include bending a first edge (e.g., 20) of the strip upwardly and bending a second edge (e.g., 22) of the strip downwardly. For example, the flat aluminum alloy strip (e.g., 18) can be fed through a die such that the first and second edges can be sufficiently bent. Forming the aluminum alloy strip into the interlocking armor layer can further include engaging the first edge with the second edge of the aluminum alloy strip to form the interlocking armor layer (e.g., 16). It will be appreciated that a more pronounced bend of the first and second edges can better facilitate engagement between wound portions of the interlocking armor layer. In certain embodiments, die settings on armoring equipment can be adjusted such that respective planes (e.g., P1, P2) formed by each of the first edge (e.g., 20) and the second edge (e.g., 22) can be substantially parallel to each other.

As described herein, in certain embodiments, no heat treatment is applied once the aluminum alloy strip is made. For example, no annealing can be performed during or subsequent to strip rolling. Accordingly, in certain embodiments, the entire method of forming an interlocking armor layer can be continuous. For example, the aluminum alloy described herein can be continuously cast, continuously hot rolled into a rod and cooled, continuously strip rolled, and then continuously processed and wound into the interlocking armor layer. It will be appreciated, however, that one or more steps can be intermittent in other embodiments. In certain embodiments, full-speed production on the armoring equipment can run up to about 1,200 rpm.

### EXAMPLES

Comparative Examples 1, 2, and 3 were aluminum alloys formed having the compositions shown below in Table 1.

TABLE 1

| | Comparative | Comparative | Comparative |
|---|---|---|---|
| | Ex. 1 (wt. %) | Ex. 2 (wt. %) | Ex. 3 (wt. %) |
| Component | AA5005 | AA5050 | AA8112 |
| Magnesium | 0.761 | 1.205 | 0.228 |
| Manganese | 0.100 | 0.103 | 0.103 |
| Silicon | 0.048 | 0.055 | 0.032 |
| Iron | 0.098 | 0.094 | 0.088 |
| Copper | 0.001 | 0.001 | 0.357 |
| Chromium | 0.057 | 0.077 | 0.001 |
| Zinc | 0.002 | 0.002 | 0.002 |
| Titanium | 0.013 | 0.012 | 0.012 |
| Boron | 0.003 | 0.002 | 0.003 |
| Gallium | 0.013 | 0.014 | 0.013 |
| Vanadium | 0.008 | 0.015 | 0.016 |
| Others (each) | 0.001 (max) | 0.001 (max) | 0.001 (max) |
| Aluminum | Remainder | Remainder | Remainder |

Table 2, shown below, provides the results for 0.500 in. ×0.025 in. (12.70 mm×0.635 mm) strips. Multiple tests were run for each respective comparative example (e.g., 1A and 1B represent the results of two distinct tests performed for the aluminum alloy of Comparative Example 1). Armor layers formed from each of the Comparative Examples 1A, 1B, 2A, 2B, 3A, and 3B were found to pass the tension test and bend test. And while portions of armor could be formed from each of Comparative Examples 1A, 1B, 2A, 2B, 3A, and 3B, interlocking armor layers could not be produced consistently and continuously at full speed from any of the formulations. As shown in Table 2, each comparative example experienced multiple breaks during formation of the armor layer, as the armor layers were generally too brittle.

TABLE 2

| | | Tension | | |
|---|---|---|---|---|
| | Rod Coiling | Test (300 | Bend | Armor |
| Example | Condition | lb.) | Test | Breaks |
| Comp. Ex. | Quenched | Pass | Pass | Yes, Multiple |
| 1A | Rod | | | |
| Comp. Ex. | Hot Coiled | Pass | Pass | Yes, Multiple |
| 1B | Rod | | | |
| Comp. Ex. | Quenched | Pass | Pass | Yes, Multiple |
| 2A | Rod | | | |
| Comp. Ex. | Hot Coiled | Pass | Pass | Yes, Multiple |
| 2B | Rod | | | |
| Comp. Ex. | Quenched | Pass | Pass | Yes, Multiple |
| 3A | Rod | | | |
| Comp. Ex. | Hot Coiled | Pass | Pass | Yes, Multiple |
| 3B | Rod | | | |

Table 3, as shown below, provides the results for 0.375 in.×0.022 in. (9.53 mm×0.559 mm) strips. Armor layers formed from each of the Comparative Examples 1C, 1D, 2C, 2D, 3C, and 3D were found to pass the bend test. However, none of the armor layers formed from each of Comparative Examples 1C, 1D, 2C, 2D, 3C, and 3D were able to pass the tension test (at 300 lb).

TABLE 3

| | | Tension | |
|---|---|---|---|
| | Rod Coiling | Test (300 | Bend |
| Example | Condition | Ib.) | Test |
| Comp. Ex. | Quenched | Fail | Pass |
| 1C | Rod | | |
| Comp. Ex. | Hot Coiled | Fail | Pass |
| 1D | Rod | | |
| Comp. Ex. | Quenched | Fail | Pass |
| 2C | Rod | | |
| Comp. Ex. | Hot Coiled | Fail | Pass |
| 2D | Rod | | |
| Comp. Ex. | Quenched | Fail | Pass |
| 3C | Rod | | |
| Comp. Ex. | Hot Coiled | Fail | Pass |
| 3D | Rod | | |

Table 4, as shown below, provides the results for 0.375 in. ×0.016 in. (9.53 mm×0.406 mm) strips. Armor layers formed from each of the Comparative Examples 1E, 1F, 2E, 2F, 3E, and 3F were found to pass the bend test. However, most of the armor layers formed from each of Comparative Examples 1E, 1F, 2E, 2F, 3E, and 3F failed to pass the tension test (at 150 lb). In order to pass the tension test, a comparative example needed to consistently exhibit sufficient strength. Otherwise, the armor layer was characterized as failing the tension test.

TABLE 4

| | | Tension Test | |
|---|---|---|---|
| | Rod Coiling | (150 | Bend |
| Example | Condition | lb.) | Test |
| Comp. Ex. | Quenched | Pass | Pass |
| 1E | Rod | | |
| Comp. Ex. | Hot Coiled | Fail | Pass |
| 1F | Rod | | |
| Comp. Ex. | Quenched | Fail | Pass |
| 2E | Rod | | |
| Comp. Ex. | Hot Coiled | Fail | Pass |
| 2F | Rod | | |
| Comp. Ex. | Quenched | Fail | Pass |
| 3E | Rod | | |
| Comp. Ex. | Hot Coiled | N/A | Pass |
| 3F | Rod | | |

Based on the results of Tables 2-4, it was determined that different formulations were needed to provide armor layers that would be not only pass tension and flexibility tests but could also produce an interlocking armor layer consistently, reliably, and continuously at full speed.

Inventive Example 1 was an aluminum alloy having a composition shown below in Table 5.

TABLE 5

| | Amount |
|---|---|
| Component | (wt. %) |
| Magnesium | 1.495 |
| Manganese | 0.105 |
| Silicon | 0.052 |
| Iron | 0.104 |
| Copper | 0.001 |
| Chromium | 0.072 |
| Zinc | 0.002 |
| Titanium | 0.010 |
| Gallium | 0.014 |
| Vanadium | 0.005 |
| Others (each) | 0.003 (max) |
| Aluminum | Remainder |

Table 6, as shown below, provides the results for 0.500 in. ×0.023 in. (12.70 mm×0.584 mm) and 0.750 in. ×0.025 in. (19.05 mm×0.635 mm) strips. Armor layers formed from each of the Inventive Examples 1A, 1B, 1C, and 1D were found to pass the tension test (at 300 lb.) and bend test. Moreover, these armor layers formed from each of the Inventive Examples 1A, 1B, 1C, and 1D were also deemed to have acceptable performance, such that strips made from the aluminum alloys formed from the above-described composition can be consistently, reliably, and continuously run, at full speed, to produce an interlocking armor layer, whether the hot coiling or quenching were employed in the respective methods of forming the same.

TABLE 6

| | | | Rod | | | |
|---|---|---|---|---|---|---|
| | Strip Dimensions | | Coiling | Tension Test | Bend | Product |
| Example | in. × in. | mm × mm | Condition | (300 lb.) | Test | Performance |
| Inv. Ex. | 0.750 × | 19.05 × | Hot Coiled | Pass | Pass | Acceptable |
| 1A | 0.025 | 0.635 | Rod | | | |
| Inv. Ex. | 0.750 × | 19.05 × | Quenched | Pass | Pass | Acceptable |
| 1B | 0.025 | 0.635 | Rod | | | |
| Inv. Ex. | 0.500 × | 12.70 × | Hot Coiled | Pass | Pass | Acceptable |
| 1C | 0.023 | 0.584 | Rod | | | |
| Inv. Ex. | 0.500 × | 12.70 × | Quenched | Pass | Pass | Acceptable |
| 1D | 0.023 | 0.584 | Rod | | | |

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of ordinary skill in the art. Rather it is hereby intended the scope be defined by the claims appended various embodiments. The scope is, of course, not limited to the examples or embodiments set forth herein, but can be employed in any number of applications and equivalent articles by those of hereto.

What is claimed is:

1. A cable comprising:
a cable core including one or more conductors; and
an interlocking armor layer surrounding the cable core, the interlocking armor layer formed from an aluminum alloy, the aluminum alloy comprising:
about 1.3% to about 1.7%, by weight, magnesium;
about 0.05% to about 0.15%, by weight, manganese; and
the balance is aluminum.

2. The cable of claim 1, wherein the aluminum alloy comprises at least about 97.5%, by weight, aluminum.

3. The cable of claim 1, wherein the aluminum alloy comprises about 1.4% to about 1.6%, by weight, magnesium.

4. The cable of claim 1, wherein the aluminum alloy comprises about 0.1% to about 0.12%, by weight, manganese.

5. The cable of claim 1, wherein the aluminum alloy further comprises up to about 0.15%, by weight, chromium.

6. The cable of claim 1, wherein the aluminum alloy further comprises up to about 0.2%, by weight, iron.

7. The cable of claim 1, wherein the aluminum alloy further comprises up to about 0.15%, by weight, of total impurities.

8. The cable of claim 1, wherein the cable meets or exceeds the requirements of one or more of Underwriters Laboratory (“UL”) 4 (2021), UL 1569 (2018), and Canadian Standard Association (“CSA”) Group standard C22.2 No. 51:20 (2000).

9. The cable of claim 1, wherein the interlocking armor layer meets or exceeds the requirements of UL 1 (2023).

10. The cable of claim 1 has a bend radius that is a minimum of nine times the overall diameter of the cable.

11. The cable of claim 1, wherein the interlocking armor layer is formed from a continuous strip, the strip having a top surface and a bottom surface and a first edge extending upwardly and a second edge extending downwardly;
wherein the top surface of the first edge engages the bottom surface of the second edge to form the interlocking armor layer; and
wherein respective planes formed by each of the first edge and second edge are substantially parallel to each other.

12. The cable of claim 1, wherein the aluminum alloy consists essentially of:
about 1.3% to about 1.7%, by weight, magnesium;
about 0.05% to about 0.15%, by weight, manganese;
up to about 0.15%, by weight, chromium;
up to about 0.2%, by weight, iron;
up to about 0.15%, by weight, of total impurities; and
the balance is aluminum.

13. A method of forming an interlocking armor layer for a cable, the method comprising:
making an aluminum alloy strip formed from an aluminum alloy, wherein the aluminum alloy comprises:
about 1.3% to about 1.7%, by weight, magnesium;
about 0.05% to about 0.15%, by weight, manganese; and
the balance is aluminum; and
forming the aluminum alloy strip into the interlocking armor layer; and
wherein no heat treatment is applied once the aluminum alloy strip is made.

14. The method of claim 13, wherein the aluminum alloy comprises at least about 97.5%, by weight, aluminum.

15. The method of claim 13, wherein the step of forming the aluminum alloy strip into the aluminum alloy armor layer comprises strip rolling; and wherein no annealing is performed during or subsequent to strip rolling.

16. The method of claim 13, wherein the step of forming the aluminum alloy strip into the interlocking armor layer comprises bending a first edge of the strip upwardly and bending a second edge of the strip downwardly.

17. The method of claim 16, wherein bending the first edge of the strip upwardly and bending the second edge of the strip downwardly comprises bending the first edge and the second edge such that a first plane defined by the first edge and a second plane defined by the second edge are substantially parallel to each other.

18. The method of claim 16, wherein the step of forming the aluminum alloy strip into the interlocking armor layer comprises engaging the first edge with the second edge of the aluminum alloy strip to form the interlocking armor layer.

19. The method of claim 18, wherein the method of forming an interlocking armor layer is continuous.

20. The method of claim 13, wherein the interlocking armor layer meets or exceeds the requirements of Underwriters Laboratory (“UL”) 1 (2023).
